(19) United States
(12) Patent Application Publication
(10) Pub. No.: US 2008/0029623 A1
(43) Pub. Date: Feb. 7, 2008

(54) FUEL INJECTOR

(75) Inventors: Fumiyasu SUGIYAMA, Osaka (JP); Tsuneaki AOKI, Obu-shi (JP); Hiroshi KAWAZOE, Obu-shi (JP)

Correspondence Address: DENNISON, SCHULTZ & MACDONALD, 1727 KING STREET, SUITE 105, ALEXANDRIA, VA, 22314, US

(73) Assignee: AISAN KOGYO KABUSHIKI KAISHA, Obu-shi (JP)

(21) Appl. No.: 11/828,599

(22) Filed: Jul. 26, 2007

(30) Foreign Application Priority Data
Aug. 1, 2006 (JP) 2006-210237

(51) Int. Cl. B05B 1/30; F02M 61/18

(52) U.S. Cl. 239/569

(57) ABSTRACT

A fuel injector 10 includes a valve 30, a valve seat 40 and a plate 42. The valve 30 has a ball valve 32. The valve seat 40 has a valve contact surface 41b that the ball valve 32 contacts. The plate 42 has fuel jet openings 42a. A coating film having high fuel flowability is formed at least on the inner peripheral surface of the fuel jet holes 42a.

### BACKGROUND OF THE INVENTION

1. Field of the Invention

The present invention relates to a fuel injector for injecting fuel.

2. Description of the Related Art

Japanese laid-open patent publication No. 9-112392 discloses a fuel injector which includes a valve and a valve seat having fuel jet holes. In this known fuel injector, fuel is injected through the fuel jet holes when the valve is separated from the valve seat, while the fuel injection is stopped when the valve contacts the valve seat. In such a fuel injector, deposits may be built up in or around the fuel jet holes and interfere with proper fuel injection through the fuel jet holes. Therefore, in this known fuel injector, a coating film made of an oil-repellant material is formed in and around the fuel jet holes. On the coating film formed only of an oil-repellant material, adhered substance can be agglomerated into a ball-like form, so that the adhered substance can be prevented from being adhered in a film-like form. However, the adhered substance has poor flowability. Therefore, agglomerated fuel may be adhered to the region of the fuel jet holes. In this case, such agglomerated fuel adhered to the region of the fuel jet holes may form the core of deposit growth. Thus, this known technique has only a limited effect in preventing buildup of deposits in the region of fuel jet holes.

### SUMMARY OF THE INVENTION

Accordingly, it is an object of the present invention to provide an effective technique for preventing buildup of deposits in the region of fuel jet holes.

According to the present invention, a valve contact surface, a valve and at least one fuel jet hole are disposed in a fuel passage through which fuel flows. The valve can move between a closed position in which it is in contact with the valve contact surface and an open position in which it is out of contact with the valve contact surface. Typically, the valve moves by the biasing force of a spring and by the electromagnetic force generated by an electromagnetic coil. The at least one fuel jet hole are disposed downstream side of the valve contact surface. When the valve is separated from the valve contact surface, the at least one fuel jet hole is opened and fuel is injected through the fuel jet hole. On the other hand, when the valve contacts the valve contact surface, the at least one fuel jet hole is closed and fuel injection through the fuel jet hole is stopped.

In one aspect of the present invention, in order to prevent buildup of deposits in the region of the fuel jet hole, a coating film having high fuel flowability is formed at least on the inner peripheral surface of the fuel jet hole. Various methods can be used to form the coating film. On the surface of the coating film, oil drops are acted upon by the repelling power of the oil-repellent component so as to be levitated from the film surface, and simultaneously acted upon by the attracting power of the lipophilic component and by inertial and gravitational force of the oil drops so as to be moved downward along the surface of the coating film. Therefore, all of the oil drops readily slide down along the surface of the coating film without staying on the film surface.

In the coating film, in order to provide high fuel flowability, an oil-repellent component and a lipophilic component are dispersed. As the oil-repellent component of the coating film, fluorine resins such as tetrafluoroethylene copolymer (TEFC), polytetrafluoroethylene (PTFE) and perfluoroalkoxyalkane (PFA) can be used. As the lipophilic component of the coating film, silicone resin (such as denatured organo polysiloxane), inorganic silicon oxide (SiO₂), methyl group modified polymer (such as polypropylene (PP)), metal (such as nickel, cobalt, manganese) and metal oxide can be used.

Preferably, tetrafluoroethylene copolymer as the oil-repellent component and denatured silicone as the lipophilic component are dispersed in the coating film. Further, in the coating film, denatured silicone may be dispersed in the proportion of 0.02 to 50 wt % to tetrafluoroethylene copolymer.

More preferably, in an area where the coating film is formed, a binding layer in which the substrate and the tetrafluoroethylene copolymer are bound together by a silane coupling agent is formed on the surface of the substrate.

In another aspect of the present invention, in order to prevent buildup of deposits in the region of fuel jet holes, a coating film containing perfluoro polyether compound is formed at least on the inner peripheral surface of the fuel jet holes. Various methods can be used to form the coating film.

Preferably, in an area where the coating film is formed, a binding layer in which the substrate and the perfluoro polyether compound are bound together via a phosphate group may be formed on the surface of the substrate.

In each aspect of the present invention, it is essential that the coating film is provided at least on the inner peripheral surface of the fuel jet hole, or preferably on the inner peripheral surface of the fuel passage located downstream from the valve contact surface (including the valve contact surface).

Further, one substrate having the valve contact surface and the at least one fuel jet hole can be used, or preferably, one substrate having the valve contact surface and another substrate having the at least one fuel jet hole may be used.

Other objects, features and advantages of the present invention will be readily understood after reading the following detailed description together with the accompanying drawings and the claims.

### BRIEF DESCRIPTION OF THE DRAWINGS

FIG. 1 is a sectional view showing a fuel injector according to a first embodiment of the invention.

FIG. 2 is an enlarged view of part A in FIG. 1.

FIG. 3 schematically shows the state of a coating film of a first embodiment.

FIG. 4 schematically shows the molecular structure of the coating film of the first embodiment.

FIG. 5 schematically shows the mechanism of oil sliding on the coating film of the first embodiment.

FIG. 6 is a graph showing the relationship between the oil sliding angle (°) and the mix proportion (wt %) of denatured silicone to tetrafluoroethylene copolymer in the coating film of the first embodiment.

FIG. 7 schematically shows the molecular structure of the coating film of a second embodiment.

FIG. 8 schematically shows the mechanism of oil sliding on the coating film of the second embodiment.

FIG. 9 shows a first example of the coating area and the coating method.

FIG. 10 shows a second example of the coating area and the coating method.

FIG. 11 shows a third example of the coating area and the coating method.

### DETAILED DESCRIPTION OF THE INVENTION

In the fuel injector according to the present invention, a valve contact surface, a valve and at least one fuel jet hole are disposed in a fuel passage through which fuel flows. The at least one fuel jet hole is disposed downstream of the valve contact surface. When the valve is separated from the valve contact surface, fuel is injected through the at least one fuel jet hole, while, when the valve contacts the valve contact surface, fuel injection through the at least one fuel jet hole is stopped.

In a fuel injector of this type, fuel may possibly be agglomerated in the region of the fuel jet holes, and the agglomerated fuel may form the core of deposit formation or growth. The agglomerated fuel and deposits will interfere with proper fuel injection through the fuel jet hole.

In one embodiment of the present invention, in order to prevent buildup of deposits in the region of fuel jet hole, a coating film having high fuel flowability is formed at least on the inner peripheral surface of the fuel jet hole. In the coating film, an oil-repellent component and a lipophilic component are dispersed. The lipophilic component of the coating film provides an attracting power attracting oil drops to the surface of the coating film. Further, the oil-repellent component of the coating film provides a repelling power levitating or repelling oil away from the surface of the coating film. Therefore, the coating film in which the oil-repellent component and the lipophilic component are dispersed always exerts the attracting power and the repelling power upon oil drops on the surface of the coating film. Thus, oil drops on the surface of the coating film are acted upon by the repelling power of the oil-repellent component so as to be levitated from the film surface, and simultaneously acted upon by the attracting power of the lipophilic component and by inertial and gravitational force of the oil drops so as to be moved downward along the surface of the coating film. Therefore, all of the oil drops readily slide down along the surface of the coating film without staying on the film surface.

Thus, by forming the coating film having high fuel flowability at least on the inner peripheral surface of the fuel jet hole, fuel can be prevented from being agglomerated in the region of the fuel jet hole. Further, agglomerated fuel can be prevented from forming the core of deposit growth. As a result, the atomized form and the injection amount of fuel to be injected through the fuel jet hole can be stabilized. Further, the startability can be improved, and the change of amount of fuel consumption can be reduced.

As the oil-repellent component of the coating film, fluorine resins such as tetrafluoroethylene copolymer (TEFC), polytetrafluoroethylene (PTFE) and perfluoroalkoxyalkane can be used. As the lipophilic component of the coating film, silicone resin (such as denatured organo polysiloxane), inorganic silicon oxide (SiO₂), methyl group modified polymer (such as polypropylene (PP)), metal (such as nickel, cobalt, manganese) and metal oxide can be used.

It is essential that the coating film is provided at least on the inner peripheral surface of the fuel jet hole, or preferably on the inner peripheral surface of the fuel passage located downstream from the valve contact surface. The “inner peripheral surface of the fuel passage located downstream from the valve contact surface” includes the valve contact surface, the inner peripheral surface of the fuel jet hole, and the inner peripheral surface of the fuel passage defined between the valve contact surface and the fuel jet hole. With this arrangement, the atomized form and the injection amount of fuel to be injected through the fuel jet holes can be further stabilized.

Further, one substrate having the valve contact surface and the fuel jet hole can be used, or preferably, one substrate having the valve contact surface and another substrate having the fuel jet hole may be formed. For example, the valve seat comprising the substrate having the valve contact surface and the plate comprising the substrate having the fuel jet hole may be used. The plate is disposed on the downstream side of the valve contact surface. Thus, the fuel injector can be readily manufactured.

Preferably, a coating film in which tetrafluoroethylene copolymer as the oil-repellent component and denatured silicone as the lipophilic component are dispersed is used. Further, in the coating film, denatured silicone may be dispersed in the proportion of 0.02 to 50 wt % to tetrafluoroethylene copolymer. By providing such a coating film, the oil sliding angle can be made smaller, so that a particularly excellent oil sliding property can be obtained. The “oil sliding angle” is the inclination angle of the surface at which an oil drop starts moving (sliding down) on the surface.

More preferably, in the area where the coating film is formed, a binding layer in which the substrate and the tetrafluoroethylene copolymer are bound together by a silane coupling agent may be formed on the surface of the substrate. This binding layer has a molecular structure in which an OH (hydroxy) group of a natural oxide film on the surface of the substrate and Si (silicon) are linked and bound together. With this molecular structure, the coating film can be more strongly adhered to the substrate.

In another embodiment of the present invention, in order to prevent buildup of deposits in the region of fuel jet hole, a coating film containing perfluoro polyether compound is formed at least on the inner peripheral surface of the fuel jet hole. In the coating film containing perfluoro polyether compound, fluorine molecules are arranged like carpet pile. In this coating film, a molecular chain easily rotates in the area of ether binding (C—O—C). Further, the binding area between the substrate and the coating film is flexible and the molecular chain itself easily bends. Thus, the molecular chain can move in a wider range. Therefore, movement of oil drops is not hindered, so that high fuel flowability can be realized. Thus, fuel can be prevented from being agglomerated in the region of the fuel jet hole.

Preferably, in the area where the coating film is formed, a binding layer in which the substrate and the perfluoro polyether compound are bound together via a phosphate group may be formed on the surface of the substrate. This binding layer has a molecular structure in which a phosphate group on the end of perfluoro polyether compound and an OH (hydroxy) group of a natural oxide film on the surface of the substrate are linked and bound together. With this molecular structure, the coating film can be more strongly adhered to the substrate.

Also in this embodiment, preferably, the coating film is formed on an inner peripheral surface of a fuel passage located downstream from the valve contact surface. Further, one substrate having the valve contact surface and another substrate having the fuel jet hole may preferably be used.

Each of the additional features and method steps disclosed above and below may be utilized separately or in conjunction with other features and method steps to provide improved fuel injectors. Representative examples of the present invention, which examples utilized many of these additional features and method steps in conjunction, will now be described in detail with reference to the drawings. This detailed description is merely intended to teach a person skilled in the art further details for practicing preferred aspects of the present teachings and is not intended to limit the scope of the invention. Only the claims define the scope of the claimed invention. Therefore, combinations of features and steps disclosed within the following detailed description may not be necessary to practice the invention in the broadest sense, and are instead taught merely to particularly describe some representative examples of the invention.

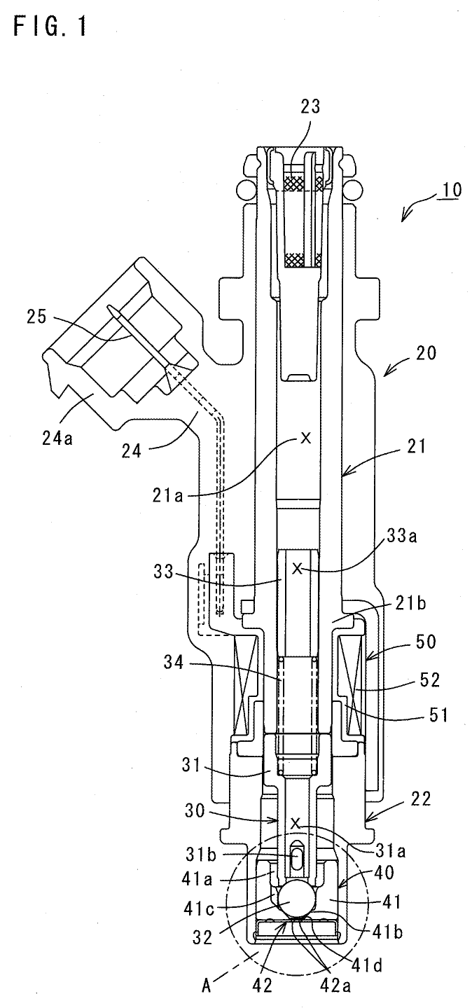

FIG. 1 is a sectional view showing a fuel injector 10 according to a first embodiment of the present invention. The fuel injector 10 injects gasoline (hereinafter referred to as “fuel”) in the form of liquid which is supplied from a fuel tank into a cylinder of an internal combustion engine. The fuel injector 10 includes an injector body 20, a valve 30, a valve seat 40 and a driving section 50. The fuel injector 10 is also called as an “injector”.

The injector body 20 has a generally cylindrical shape. The inner space of the injector body 20 serves as a fuel passage 21a. Fuel flows through the fuel passage 21a from top to bottom in FIG. 1. The injector body 20 has a fixed core 21 on the upstream side with respect to the direction of fuel flow (the upper side as viewed in FIG. 1) (hereinafter referred to as “the upstream side”), a body 22 on the downstream side with respect to the direction of fuel flow (the lower side as viewed in FIG. 1) (hereinafter referred to as “the downstream side”), and a connector 24. The fixed core 21 and the body 22 are made of magnetic metal. A flange 21b is formed on the outer peripheral surface of the fixed core 21 in a predetermined position and protrudes radially outward.

Further, a fuel filter 23 is disposed in the upstream portion of the fuel passage 21a and serves to filter fuel to be supplied to the fuel passage 21a.

The valve 30 is disposed in a fuel passage 33a through which fuel flows. The valve 30 includes a movable core 31 and a ball valve 32 that is disposed on the downstream side of the movable core 31. The movable core 31 is made of magnetic metal and has a generally cylindrical shape. The inner space of the movable core 31 serves as a fuel passage 31a. Further, a communication hole 31b is formed through the side wall of the movable core 31 and provides communication between the fuel passage 31a and a fuel passage 41a which is defined by the inner space of a valve seat body 41. The ball valve 32 has a spherical shape. The valve 30 is disposed such that it can move in the axial direction of the fuel injector 10 (vertically as viewed in FIG. 1) with respect to the injector body 20 and the valve seat 40. In this embodiment, the movable core 31 of the valve 30 is disposed such that it can slide along the inner peripheral surface of the body 22.

The valve seat 40 has a valve seat body 41. The valve seat body 41 is mounted in the body 22, for example, by press-fitting. The valve seat body 41 has a generally cylindrical shape. The inner space of the valve seat body 41 serves as a fuel passage 41a. An opening 41d is formed in the bottom of the valve seat body 41 and communicates with the fuel passage 41a. In the valve seat body 41, an inclined valve contact surface 41b is formed on the upstream side of the opening 41d. The valve contact surface 41b forms a part of the fuel passage 41a. A plate 42 having fuel jet holes 42a is disposed on the downstream side of the valve seat body 41 (the downstream side of the valve contact surface 41b), so that the plate 42 closes the opening 41d of the valve seat body 41. Therefore, fuel is injected through the fuel jet holes 42a of the plate 42.

A groove 41c is formed in the inner peripheral surface of the valve seat body 41 and extends in the axial direction (vertically as viewed in FIG. 1). Thus, fuel can be led from the fuel passage 41a to the fuel jet holes 42a of the plate 42 via the groove 41d. In this embodiment, when the ball valve 32 contacts the valve contact surface 41b, the fuel jet holes 42a are closed and fuel injection is stopped (in the “valve closed state”). On the other hand, when the ball valve 32 is separated from (out of contact with) the valve contact surface 41b, the fuel jet holes 42a are opened and fuel injection is permitted (in the “valve open state”).

A spring 34 is disposed between a spring adjuster 33 and the valve 30 (the movable core 31) and normally urges the valve 30 in the direction of the valve seat 40 (in the closing direction that closes the fuel jet holes 42a). The spring adjuster 33 is press-fitted and fixed in a predetermined position in the fixed core 21. The biasing force of the spring 34 can be adjusted by adjusting the position of the spring adjuster 33 to be fixed with respect to the fixed core 21. The inner space of the spring adjuster 33 serves as a fuel passage 33a. Thus, fuel can be led to the fuel jet holes 42a via the fuel filter 23, the fuel passages 21a, 33a, 31a, 41a and the groove 41c.

Further, a slight clearance is formed between the fixed core 21 and the movable core 31 when the ball valve 32 of the valve 30 is in contact with the valve contact surface 41b of the valve seat body 41.

The driving section 50 includes the fixed core 21, an electromagnetic coil 52 and the body 22. The coil winding forming the electromagnetic coil 52 is wound on a bobbin 51 which is fitted on the fixed core 21. The fixed core 21 is typically covered with resin, with the bobbin 51 having the coil winding being fitted thereon. At this time, an end portion of a connecting wire 25 of which end is connected to the coil winding of the electromagnetic coil 52 is integrally formed, for example, by insert molding. When electric current flows through the coil winding of the electromagnetic coil 52, the electromagnetic coil 52 generates an electromagnetic force.

The body 22 has a generally cylindrical shape. The body 22 is disposed over the bobbin 51 such that the outer peripheral surface of the flange 21b of the fixed core 21 contacts the inner peripheral surface of the body 22. For example, the fixed core 21 is press fitted into the body 22. At this time, the upstream end (upper end as viewed in FIG. 1) of the body 22 is located upstream of the flange 21b.

A connector 24 made of resin is formed on the fixed core 21. A socket 24a is formed in the connector 24 and can receive a connecting terminal which is connected to an external power source. One end of the connecting wire 25 is connected to the coil winding of the electromagnetic coil 52 and the other end is placed in the socket 24a. Thus, the coil winding of the electromagnetic coil 52 can be connected to the external power source via the connecting wire 25.

The connecting wire 25 for connecting the coil winding of the electromagnetic coil 52 and the external power source may comprise one connecting wire or a plurality of connecting wires connected in series. For example, one of the connecting wires may jut out the bobbin 51 and another may be embedded in the connector 24.

The fuel injector 10 of this embodiment operates as follows.

When current is supplied from the external power source to the coil winding of the electromagnetic coil 52 via the connecting wire 25, magnetic flux flows to the body 22 through the fixed core 21 and the movable core 31 and thus generates a driving force of moving the valve 30 toward the fixed core 21. As a result, the valve 30 moves in a direction (upward as viewed in FIG. 1) away from the valve seat 40. The valve 30 then stops when the movable core 31 contacts the fixed core 21. At this time, the ball valve 32 is separated from the valve contact surface 41b of the valve seat body 41. Thus, the fuel jet holes 42a of the plate 42 are opened, and fuel is injected through the fuel jet holes 42a.

When the supply of current to the coil winding of the electromagnetic coil 52 is stopped, the valve 30 moves in a direction (downward as viewed in FIG. 1) toward the valve contact surface 41b of the valve seat body 41 by the biasing force of the spring 34. The valve 30 then stops when the ball valve 32 contacts the valve contact surface 41b of the valve seat body 41. At this time, the fuel jet holes 42a of the plate 42 are closed, and the fuel injection from the fuel jet holes 42a is stopped.

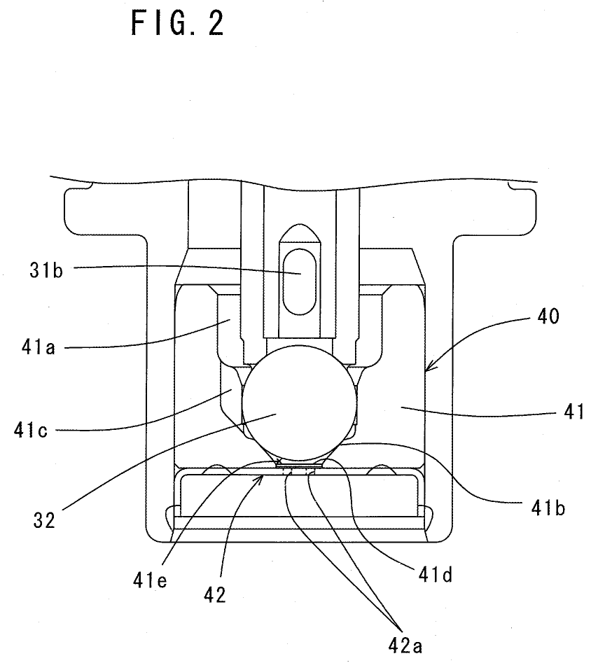

FIG. 2 is an enlarged view of part A in FIG. 1.

The ball valve 32, the valve seat 40 (the valve seat body 41) and the plate 42 are formed by processing a substrate made of metal materials, such as iron, iron alloy (carbon steel, special steel, heat-resistant steel, stainless steel, etc.), copper, copper alloy, nickel, nickel alloy, cobalt and cobalt alloy.

Further, the valve contact surface 41b of the valve seat body 41, the surface of the plate 42, and the inner peripheral surface of the fuel jet holes 42a of the plate 42 form the inner peripheral surface of a fuel passage located downstream from the valve contact surface 41b.

In a fuel injector of this type, fuel existing within a space 41e around the fuel jet holes 42a may possibly be agglomerated in the region of the fuel jet holes 42a, and the agglomerated fuel may form the core of deposit formation or growth. If a deposit is built up in and around the fuel jet holes 42a, the atomized form and the amount of fuel to be injected through the fuel jet holes 42a may vary. The space 41e is a space defined by the ball valve 32, the valve contact surface 41b and the plate 42 when the ball valve 32 is in contact with the valve contact surface 41b.

Therefore, in this embodiment, a coating film 110 or 120 having an excellent oil sliding property is provided on the inner peripheral surface of the fuel passage located downstream from the valve contact surface 41b (including the valve contact surface 41b). Specifically, the valve contact surface 41b formed on a substrate comprising the valve seat body 41, the inner peripheral surface of the fuel jet holes 42a formed in a substrate comprising the plate 42, and both surfaces of the plate 42 on the upstream and downstream sides are coated with the coating film 110 or 120. It is essential to provide the coating film 110 or 120 at least on the inner peripheral surface of the fuel jet holes 42a.

A coating film having an oil sliding property good enough to ensure reliable sliding down of oil along the surface of the coating film is used as the coating film 110 or 120.

### (Coating Film 110)

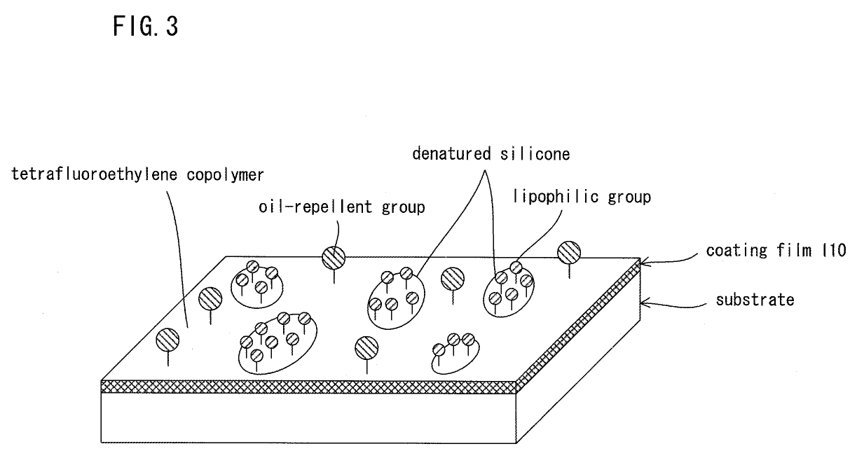

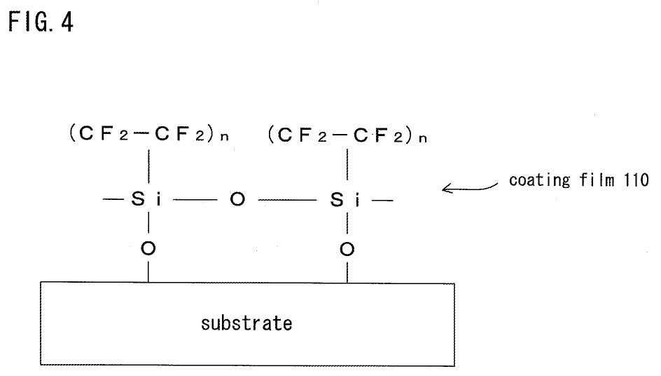

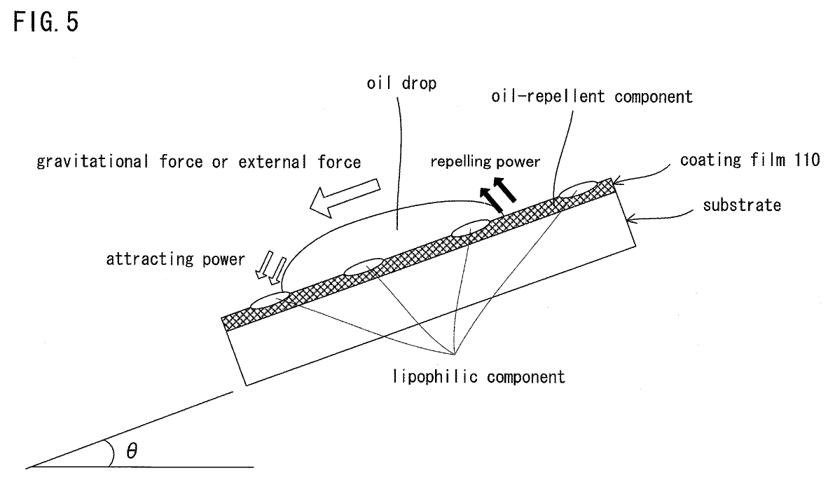

A first embodiment of the coating film 110 will now be described with reference to FIGS. 3 to 5. FIG. 3 schematically shows the state of the coating film 110. FIG. 4 schematically shows the molecular structure of the coating film 110. FIG. 5 schematically shows the mechanism of oil sliding on the coating film 110.

As shown in FIG. 3, a main material forming the coating film 110 of the first embodiment is obtained by using tetrafluoroethylene copolymer (CF₂CF₂)ₙ, as its base, which is an oil-repellent component (involving an oil-repellent group) and by dispersing denatured silicone (R₁R₂CiO)ₘ which is a lipophilic component (involving a lipophilic group) in the base oil-repellent component. Alternatively, denatured silicone which is a lipophilic component may be used as the base and tetrafluoroethylene copolymer which is an oil-repellent component can be dispersed in the lipophilic component. Aliphatic polyisocyanate as a curing agent, organosilane as an adhesion improver (a silane coupling agent), and a ketone solvent (acetone, butyl acetate, etc.) as a solvent are mixed into the above-described main material. This liquid mixture is applied to the substrate by dipping or spraying. Then, the substrate is hardened under the baking conditions of the temperature of 180° C. for 15 minutes. As a result, the substrate and the liquid mixture are bound together by silane coupling, so that the coating film 110 having a substantially uniform thickness is formed on the surface of the substrate. The thickness of the coating film 110 can be, for example, on the order of 1 μm or less.

The coating film 110 is a composite coating film in which the oil-repellent component and the lipophilic component are dispersed in each other. Such a coating film has both the functions of the oil-repellent component and the lipophilic component and is called as a “hybrid coating film”. The coating film 110 is a feature that corresponds to the “coating film in which an oil-repellent component and a lipophilic component are dispersed” according to the present invention.

As shown in FIG. 4, the coating film 110 has a molecular structure in which an OH (hydroxy) group of a natural oxide film on the surface of the substrate and Si (silicon) are linked and bound together. With this molecular structure, the binding layer in which the substrate and the tetrafluoroethylene copolymer are bound together by a silane coupling agent has excellent adhesion.

As shown in FIG. 5, the mechanism of oil sliding on the coating film 110 is based on the oil-repellent component and the lipophilic component of the coating film 110. The lipophilic component of the coating film 110 provides an attracting power of attracting oil drops to the surface of the coating film 110. Further, the oil-repellent component of the coating film 110 provides a repelling power of repelling oil away from the surface of the coating film 110. Specifically, the composite coating film 110 in which the oil-repellent component and the lipophilic component are dispersed always exerts the attracting power and the repelling power upon oil drops on the surface of the coating film 110.

Thus, when the inclination (the angle θ in FIG. 5) of the substrate is equal to or larger than the sliding angle (the sliding angle ≧θ), oil drops on the surface of the coating film 110 are repelled by the repelling power of the oil-repellent component. At the same time, the oil drops are attracted downward along the surface of the coating film 110 by gravitational force or external force and by the attracting power of the lipophilic component. At this time, all of the oil drops (oil films) slide down along the surface of the coating film 110 without staying on the film surface. Measurements made on one example of the coating film 110 show that the water contact angle is 80° and the light-oil sliding angle is 10°.

The “contact angle” is the angle between the surface on which a droplet having a predetermined volume (for example, 5 μl) is placed and a tangent to the surface of the droplet. The contact angle indicates the surface energy of the droplet. The larger the contact angle, the better the oil repellency and water repellency (the poorer lipophilicity and hydrophilicity). The “water contact angle” is the contact angle with respect to water.

Further, the “sliding angle” is the inclination angle of the surface at which a droplet of a predetermined volume (for example, 5 μl) on the surface starts sliding down. The sliding angle indicates ease of movement of droplets. Specifically, the smaller the sliding angle, the more easily the droplets can move. The “light-oil sliding angle” is the sliding angle with respect to light oil.

Therefore, with a provision of such a coating film 110 at least on the inner peripheral surface of the fuel jet holes 42a (preferably on the inner peripheral surface of the fuel passage located downstream from the valve contact surface 41b), fuel flowability can be improved in and around the fuel jet holes 42a by inertial and gravitational force of fuel during fuel injection. As a result, fuel residues which may form the core of deposit growth can be prevented from being formed in and around the fuel jet holes 42a, so that the atomized form and the injection amount of fuel can be stabilized during fuel injection. Further, the startability can be improved, and the change of the amount of fuel consumption can be reduced. Moreover, by using tetrafluoroethylene copolymer which is an oil-repellent component (involving an oil-repellent group) as a base and dispersing denatured silicone which is a lipophilic component (involving a lipophilic group) in the oil-repellent component, a fluorine-based coating film having excellent acid resistance and alkaline resistance can be obtained.

Inventors measured the oil sliding angle in order to quantitatively determine a proper range of the mix proportion of denatured silicone to tetrafluoroethylene copolymer in the coating film 110. Specifically, the measurements were made on plates coated with the coating films having different mix proportions of denatured silicone to tetrafluoroethylene copolymer. First, oil drops were dropped on each of the plates and the plate was gradually inclined. Then, the inclination angle of the plate at which each of the oil drops started moving (sliding down) on the surface of the coating film was measured as the oil sliding angle.

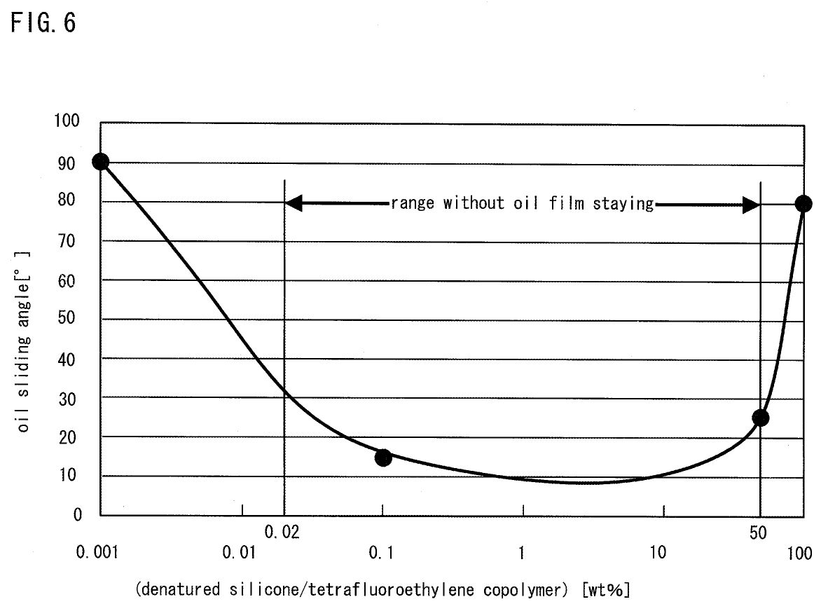

The graph of FIG. 6 shows the measurement results. In FIG. 6, the horizontal axis indicates the mix proportion (wt %: weight percent) of denatured silicone to tetrafluoroethylene copolymer, and the vertical axis indicates the oil sliding angle (°). It can be seen from FIG. 6 that, when the mix proportion of denatured silicone to tetrafluoroethylene copolymer is set within the range of 0.02 to 50 wt %, the coating film 110 can exhibit an excellent oil sliding property with smaller sliding angles while preventing oil drops (oil films) from staying on the surface of the coating film 110. More preferably, the mix proportion of denatured silicone to tetrafluoroethylene copolymer may be set within the range of 0.1 to 10 wt %. When the mix proportion is set within this range, the oil sliding angle is kept stable in the order of 10° regardless of the mix proportion, so that oil drops (oil films) can be particularly effectively prevented from staying on the surface of the coating film 110. As one example, the mix proportion between denatured silicone and tetrafluoroethylene copolymer can be 99:1 (wt %).

Further, as the oil-repellent component of the coating film 110, not only tetrafluoroethylene copolymer (TEFC), but other fluorine resins such as polytetrafluoroethylene (PTFE) and perfluoroalkoxyalkane (PFA) can also be used. As the lipophilic component of the coating film 110, not only denatured silicone, but silicone resin (such as denatured organo polysiloxane), inorganic silicon oxide (SiO₂), methyl group modified polymer (such as polypropylene (PP)), metal (such as nickel, cobalt, manganese) and metal oxide can also be used.

### (Coating Film 120)

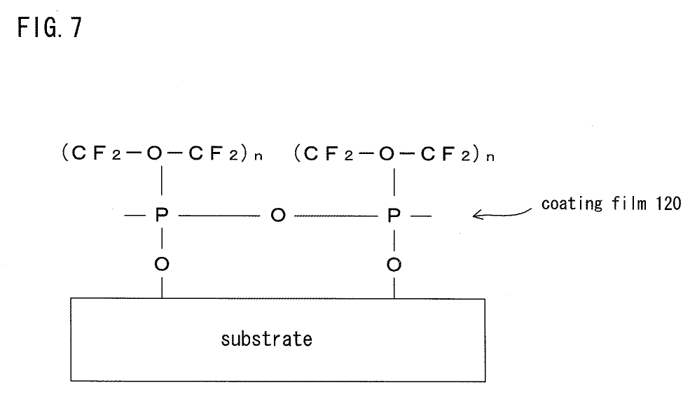

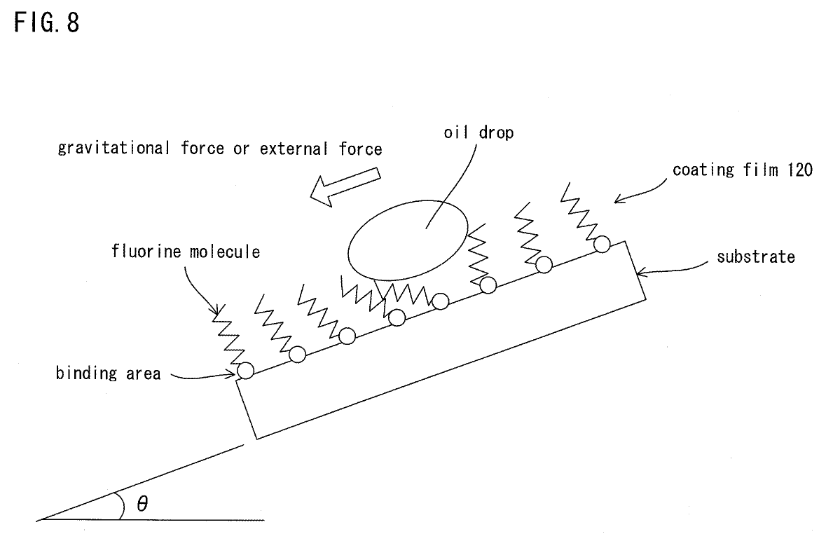

Next, a second embodiment of the coating film 120 will be described with reference to FIGS. 7 and 8. FIG. 7 schematically shows the molecular structure of the coating film 120. FIG. 8 schematically shows the mechanism of oil sliding on the coating film 120.

The coating film 120 of the second embodiment is formed by using perfluoro polyether compound (PFPE) as the main material. Perfluoro hexane as a solvent is mixed into this main material, and this liquid mixture is applied to the substrate by dipping or spraying. Then, the substrate is room-temperature dried under the conditions of the temperature of 20° C. for 15 minutes. As a result, the liquid mixture is adhered to the substrate, so that the coating film 120 having a substantially uniform thickness is formed on the surface of the substrate. The coating film 120 can have a thickness, for example, of about 1 to 10 nm. The coating film 120 is a feature that corresponds to the “coating film containing perfluoro polyether compound” according to the present invention.

As shown in FIG. 7, the coating film 120 has a molecular structure in which a phosphate group at the end of perfluoro polyether compound and an OH (hydroxy) group of a natural oxide film on the surface of the substrate are linked and bound together. With this molecular structure, the binding layer in which the substrate and the perfluoro polyether compound are bound together has excellent adhesion.

As shown in FIG. 8, the mechanism of oil sliding on the coating film 120 is based on the fluorine molecules arranged like carpet pile on the surface of the substrate. The interface of the fluorine molecules binds to the natural oxide film on the surface of the substrate via a phosphate group. In the coating film 120 having such a structure, a molecular chain easily rotates in the area of ether binding (C—O—C). Further, the binding area between the substrate and the coating film 120 is flexible and the molecular chain itself easily bends. Thus, the molecular chain has a wider range of movement. Therefore, movement of oil drops is not hindered, so that high fuel flowability can be realized.

Thus, when the inclination (the angle θ in FIG. 8) of the substrate is equal to or larger than the sliding angle (the sliding angle ≧θ), oil drops on the surface of the coating film 120 slide down along the surface of the coating film 110 without staying on the film surface.

Measurements made on one example of the coating film 120 show that the water contact angle is 108°, gasoline contact angle is 42° and the light-oil sliding angle is 390. The “gasoline contact angle” is the contact angle with respect to gasoline.

As described above, the coating film 110 or 120 is formed at least on the inner peripheral surface of the fuel jet holes 42a of the plate 42, or preferably on the inner peripheral surface of the fuel passage located downstream from the valve contact surface 41b.

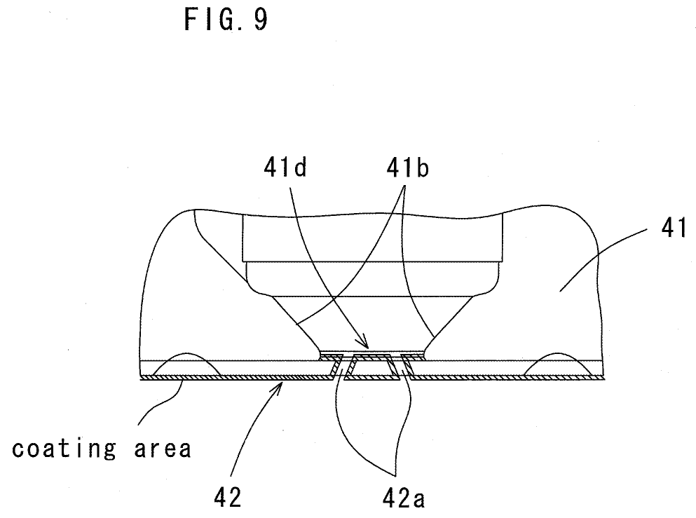

The coating area and method of formation of the coating film 110 or 120 will now be explained with reference to FIGS. 9 to 11. FIGS. 9 to 11 show first to third examples of the locating area and method of formation of the coating film 110 or 120. The hatched areas in FIGS. 9 to 11 represent the coating areas of the coating film 110 or 120.

In the first example shown in FIG. 9, first, the plate 42 is mounted on the bottom of the valve seat body 41, for example, by welding. Then, the valve contact surface 41b is masked. Subsequently, liquid for forming the coating film 110 or 120 is applied to the plate 42. In this manner, the coating film 110 or 120 is formed on the inner peripheral surface of the fuel jet holes 42a of the plate 42, the downstream-side surface of the plate 42, and a portion of the upstream-side surface of the plate 42 which corresponds in position to the opening 41d. In this method, the accuracy of the valve contact surface 41b can be maintained. Further, the coating film 110 or 120 can be formed only in the inner peripheral surface of the fuel jet holes 42a and its vicinity.

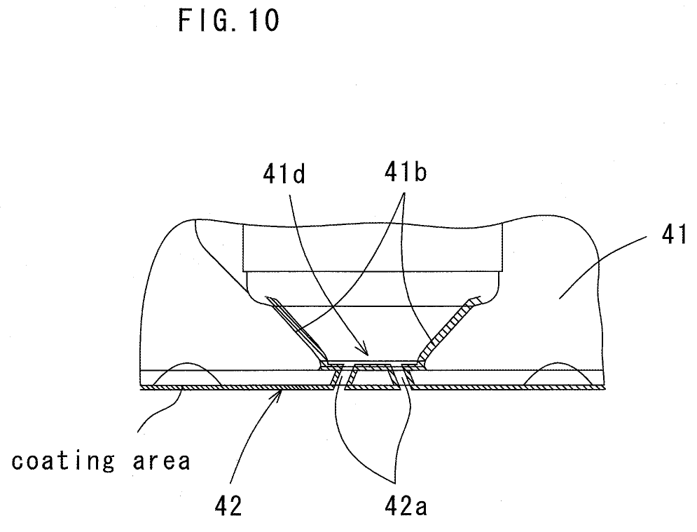

In the second example shown in FIG. 10, first, the plate 42 is mounted on the bottom of the valve seat body 41, for example, by welding. Then, liquid for forming the coating film 110 or 120 is applied to the valve contact surface 41b and the plate 42. In this manner, the coating film 110 or 120 is formed on the valve contact surface 41b, the inner peripheral surface of the fuel jet holes 42a of the plate 42, the downstream-side surface of the plate 42, and a portion of the upstream-side surface of the plate 42 which corresponds in position to the opening 41d. In this method, it is not necessary to mask the valve contact surface 41b, so that the coating film 110 or 120 can be easily formed on the inner peripheral surface of the fuel passage located downstream from the valve contact surface 41b (involving the valve contact surface 41b).

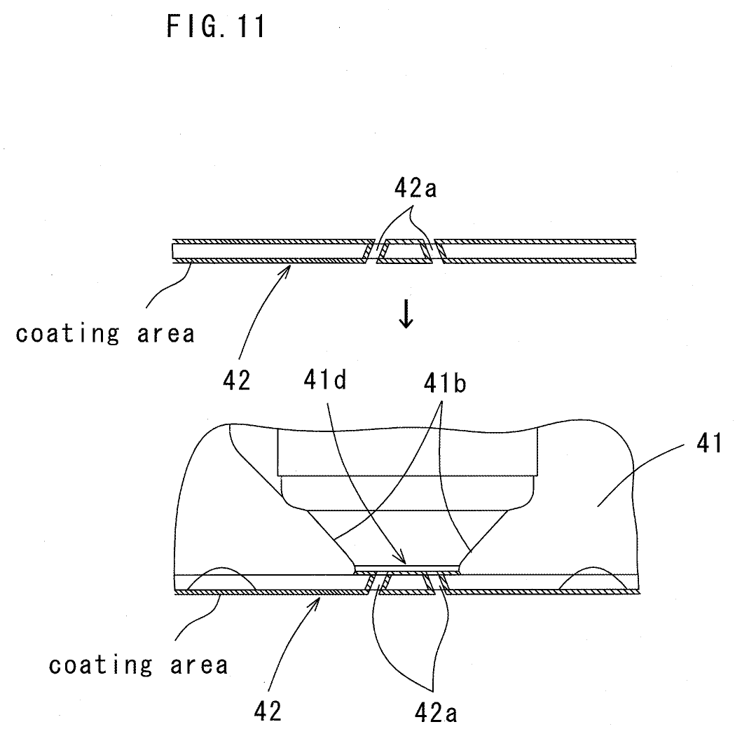

In the third example shown in FIG. 11, first, liquid for forming the coating film 110 or 120 is applied to the plate 42. Thus, the entire surface of the plate 42 including the inner peripheral surface of the fuel jet holes 42a is coated with the coating film 110 or 120. Then, the plate 42 coated with the coating film 110 or 120 is mounted on the bottom of the valve seat body 41, for example, by welding. In this method, liquid application and inspection after liquid application are facilitated. Further, it is not necessary to mask the valve contact surface 41b. Therefore, the coating film 110 or 120 can be more easily formed only in the inner peripheral surface of the fuel jet holes 42a and its vicinity.

As described above, by forming the coating film 110 or 120 having high fuel flowability at least on the inner peripheral surface of the fuel jet holes 42a, or preferably on the inner peripheral surface of the fuel passage located downstream from the valve contact surface 41b, fuel can be prevented from being agglomerated in and around the fuel jet holes 42a. As a result, the atomized form and the injection amount of fuel can be stabilized during fuel injection. Further, fuel residues which may form the core of deposit growth can be prevented from being formed. Therefore, the startability can be improved, and the change of the amount of fuel consumption can be reduced.

The present invention is not limited to the constructions that have been described as the representative embodiments, but rather, may be added to, changed, replaced with alternatives or otherwise modified without departing from the spirit and scope of the invention.

The technique for forming the coating film 110 or 120 on the surface of the substrate according to the above embodiments can also be applied to the region of the fuel jet holes of an air-assisted injector or a direct-injection type injector. Although the fuel injector having a plurality of fuel jet holes has been described in the above embodiments, the fuel injector may have at least one fuel jet hole. Although the fuel injector for injecting gasoline has been described in the above embodiments, the technique disclosed in the present invention can also be applied to other fuel injectors for injecting various kinds of fuel, such as light oil, heavy oil, liquefied petroleum gas (LPG), liquefied natural gas (LNG), and hydrogen gas.

What we claim is:

1. A fuel injector, including a valve contact surface, a valve that can contact the valve contact surface, and at least one fuel jet hole, the fuel injector being designed such that fuel is injected through the fuel jet hole when the valve is separated from the valve contact surface, while the fuel injection is stopped when the valve contacts the valve contact surface, wherein:
the at least one fuel jet hole is formed in a substrate, and
a coating film in which a lipophilic component and an oil-repellent component are dispersed is formed at least on the inner peripheral surface of the at least one fuel jet hole.

2. The fuel injector as defined in claim 1, wherein the coating film is formed on an inner peripheral surface of a fuel passage located downstream from the valve contact surface.

3. The fuel injector as defined in claim 1, wherein the substrate having the at least one fuel jet hole comprises a plate, and the plate is disposed on the downstream side of the valve contact surface.

4. The fuel injector as defined in claim 1, wherein, in the coating film, denatured silicone which is a lipophilic component is dispersed in the proportion of 0.02 to 50 wt % to tetrafluoroethylene copolymer which is an oil-repellent component.

5. The fuel injector as defined in claim 4, wherein a binding layer in which the substrate and the tetrafluoroethylene copolymer are bound together by a silane coupling agent is formed on the surface of the substrate.

6. A fuel injector, including a valve contact surface, a valve that can contact the valve contact surface, and at least one fuel jet hole, the fuel injector being designed such that fuel is injected through the fuel jet hole when the valve is separated from the valve contact surface, while the fuel injection is stopped when the valve contacts the valve contact surface, wherein:
the at least one fuel jet hole is formed in a substrate, and
a coating film containing perfluoro polyether compound is formed at least on the inner peripheral surface of the at least one fuel jet hole.

7. The fuel injector as defined in claim 6, wherein the coating film is formed on an inner peripheral surface of a fuel passage located downstream from the valve contact surface.

8. The fuel injector as defined in claim 6, wherein the substrate having the at least one fuel jet hole comprises a plate, and the plate is disposed on the downstream side of the valve contact surface.

9. The fuel injector as defined in claim 6, wherein a binding layer in which the substrate and the perfluoro polyether compound are bound together via a phosphate group is formed on the surface of the substrate.
